(19) United States
(12) Patent Application Publication
(10) Pub. No.: US 2009/0190178 A1
(43) Pub. Date: Jul. 30, 2009

(54) IMAGE FORMING APPARATUS

(76) Inventor: Daijiro SAITO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/359,027

(22) Filed: Jan. 23, 2009

(30) Foreign Application Priority Data
Jan. 25, 2008 (JP) 2008-015092

(51) Int. Cl. G06K 15/00

(52) U.S. Cl. 358/1.16

(57) ABSTRACT

Disclosed is an image forming apparatus including: an image memory to store image data to form an image with pixels aligned in a main scanning direction and a sub-scanning direction; a print head; and a correction section to perform correction processing on the image data to correct misalignment which occurs when an image is formed, wherein the correction section includes: a memory which can perform burst transfer; a first control section; line buffers; and a second control section, wherein the first control section successively writes the image data in the burst access unit in the memory and reads the image data in the burst access unit while controlling the address of the memory according to a first control signal generated based on previously set information concerning correction; and the second control section selects image data to output according to a second control signal generated based on the information.

### BACKGROUND

1. Field of the Invention

The present invention relates to an image forming apparatus which can correct misalignment in image forming due to mounting status of a print head or an alignment status of a light-emitting element of the print head.

2. Description of Related Art

Generally an image forming apparatus such as a digital multi function peripheral includes an image forming section to form an image on a sheet. The image forming section includes a writing unit as an exposing section, and an electrostatic latent image based on image data is formed by exposing the charged photoreceptor drum with the writing unit.

As a writing unit, for example, a print head such as an LED print head (LPH) is used for forming an image in a line in a main scanning direction which is orthogonal to a conveying direction (sub-scanning direction) of a sheet on which an image is to be formed.

Here, an LPH is a plurality of LED array chips, which are formed with a plurality of light-emitting elements (LED) in one straight line by a semiconductor process, mounted on a substrate along an ideal alignment line and the LPH should be mounted parallel to the rotation axis of the photoreceptor drum.

In such an image forming apparatus which uses an LPH as a writing unit, it is known that printing misalignment occurs in image forming due to mounting status of the LPH to the image forming apparatus or mounting status of the LED array chip to the substrate (alignment status of the light-emitting element).

For example, the LPH should be placed parallel to the rotation axis of the photoreceptor drum (main scanning direction), however, specifically, the LPH may be in a diagonally right up or a diagonally right down status, and is not always parallel to the main scanning direction. When an image of, for example, a straight line is formed in this state, a printing misalignment called a skew occurs where an image of a straight line is formed tilted diagonally.

It is ideal in an LPH that the LEDs of each LED array chip are installed in a row, however actually some variations occur in the mounting of each LED array chip. When an image of, for example, a straight line is formed using such an LPH, a printing misalignment called a bow occurs where a straight line is formed away from an ideal straight line in a unit of the LED array chip.

Accordingly, a technique to resolve the printing misalignment is proposed, where skew correction or bow correction is performed by adjusting (for example shifting in a sub-scanning direction) a position of image forming per pixel according to an inclination from the main scanning direction of the LPH mounted to the image forming apparatus or an amount of misalignment from a reference straight line of each LED array chip (for example, Japanese Patent Application Laid-Open Publication No. 2001-301232).

FIG. 15 is an explanatory diagram showing an example of a conventional skew/bow correction processing circuit.

This correction processing circuit is part of an image processing section and is provided in a subsequent stage of an image conversion circuit to convert RGB image data to CMYK image data. In other words, image data corrected by the correction processing circuit is output to the writing unit to perform exposing according to the corrected image data.

The correction circuit shown in FIG. 15 includes a line buffer BUF, a main scanning address counter CNT, a line number correction section DSEL, and a line number selector SEL.

The line buffer BUF includes a line buffer for each line of multistage and the line buffer has a plurality of registers to store image data corresponding to one line of each LED of the LPH. In other words, each of the line buffer stores each line of image data from the image memory directly.

The main scanning address counter CNT instructs an address which is a reading position on a line of the line buffer BUF based on a control signal.

The line number correction section DSEL determines the read line to be instructed by the line number selector SEL, based on the read line/address of the line buffer according to the control signal and a correction amount of the bow correction/skew correction in the main scanning direction.

The line number selector SEL reads an instructed address and input data specified by the corrected read line to output to the writing unit as image data.

Since the conventional correction processing circuit has the above-described structure, a number of stages of the line buffer determines the amount of misalignment which can be resolved. For example, in a case where one end of the LPH (for example, left end) is a reference position and the other end (for example, right end) is above or below N lines (inclination: N/total number of pixels in the main scanning direction), when the circuit includes a line buffer which can store N lines of image data, the data stored in the register N lines before or after the read line which is the reference line can be read, therefore the skew can be corrected.

### SUMMARY

As described above, in a conventional correction processing circuit, line buffers where the reading position can be freely controlled are made available according to the amount of misalignment which can be resolved (total maximum correction amount throughout the main scanning direction).

However, if mechanical mounting accuracy of the LPH is steady, amount of RAM space (number of stages of line buffer) necessary is in proportion with increase of resolution, therefore when the resolution of the image forming apparatus increases, the number of stages of the line buffer needs to be increased. As a result, problems occur such as increase in cost of the apparatus, complicated circuit structure, etc.

In recent years, image quality in digital equipment is becoming higher, and it appears that resolution will increase in image forming apparatuses also. However, the conventional correction processing circuit has the above-described problem and it is not suitable as a means for performing skew correction/bow correction of an image formed with a high resolution.

The present invention has been made in consideration of the above problems, and it is one of main objects to provide an image forming apparatus which can correct misalignment in image forming due to mounting status of a print head or an alignment status of a light-emitting element of the print head, which can easily adapt to increase of image forming ability (higher resolution) and reduce cost of the apparatus.

In order to achieve at least one of the above-described objects, according to an aspect of the present invention, there is provided an image forming apparatus, comprising:

an image memory to store image data to form an image composed of a plurality of pixels aligned in a main scanning direction and a sub-scanning direction;

a print head to form an image on a sheet based on the image data; and

a correction section to perform correction processing on the image data read from the image memory to correct misalignment which occurs when an image is formed due to mounting status of the print head or alignment status of a light-emitting element of the print head, wherein

the correction section includes:

a memory which can perform burst transfer, to store image data per pixel read from the image memory with the main scanning direction of the image corresponding to a column address and the sub-scanning direction of the image corresponding to a row address;

a first control section to perform address control when data is transferred in the memory;

a plurality of stages of line buffers to store image data throughout the main scanning direction transferred in burst access unit from the memory; and

a second control section to select image data to output per main scanning coordinate among a plurality of lines of image data stored in the plurality of stages of line buffers, wherein

the first control section successively writes the image data per pixel in the burst access unit in the memory and reads the image data per pixel in the burst access unit while controlling the address of the memory according to a first control signal generated based on previously set information concerning correction to transfer the image data to the line buffer; and

the second control section selects image data to output per main scanning coordinate among the plurality of lines of image data stored in the plurality of stages of line buffers according to a second control signal generated based on the information concerning correction.

According to another aspect of the present invention, there is provided an image forming apparatus, comprising:

an image memory to store image data to form an image composed of a plurality of pixels aligned in a main scanning direction and a sub-scanning direction;

and

a correction section to perform correction processing on the image data read from the image memory to correct misalignment which occurs when an image is formed due to mounting status of a print head or alignment status of a light-emitting element of the print head, wherein

the correction section includes:

a memory which can perform burst transfer, to store image data per pixel read from the image memory with the main scanning direction of the image corresponding to a column address and the sub-scanning direction of the image corresponding to a row address;

a first control section to perform address control when data is transferred in the memory;

a plurality of stages of line buffers to store image data throughout the main scanning direction transferred in burst access unit from the memory; and

a second control section to select image data to output per main scanning coordinate among a plurality of lines of image data stored in the plurality of stages of line buffers, wherein

the first control section writes the image data per pixel in the burst access unit while controlling the address of the memory according to a first control signal generated based on previously set information concerning correction and successively reads in the burst access unit the written image data to transfer to the line buffer; and

the second control section selects image data to output per main scanning coordinate among the plurality of lines of image data stored in the plurality of stages of line buffers according to a second control signal generated based on the information concerning correction.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a block diagram showing a functional structure of an image forming apparatus of the preferred embodiment;

FIG. 2 is an explanatory diagram showing an inner structure of the image forming apparatus;

FIG. 3 is an explanatory diagram showing a mounting status of an LPH;

FIG. 4 is an explanatory diagram showing a mounting status of an LED array chip;

FIG. 5 is an explanatory diagram showing a specific structure of an image processing section 70;

FIG. 6 is a conceptual diagram showing a memory space of a large capacity memory 723;

FIG. 7 is a conceptual diagram showing address control when burst transfer is performed in the large capacity memory 723;

FIG. 8 is a flowchart showing a correction processing of the image processing section 70;

FIG. 9A is an explanatory diagram showing an image formed before skew correction;

FIG. 9B is an explanatory diagram showing an image formed after skew correction;

FIG. 10A is an explanatory diagram showing an image formed before bow correction;

FIG. 10B is an explanatory diagram showing an image formed after bow correction;

FIG. 11 is an explanatory diagram showing an example of a specific structure of a fine adjustment processing section 725 used in a first example;

FIG. 12 is a timing chart showing an example of correction processing of the first example and an explanatory diagram showing an image of output image data;

FIG. 13 is an explanatory diagram showing an example of a specific structure of a fine adjustment processing section 725 used in a second example;

FIG. 14 is a timing chart showing an example of correction processing of the second example and an explanatory diagram showing an image of output image data; and

FIG. 15 is an explanatory diagram showing an example of a conventional skew/bow correction processing circuit.

### DETAILED DESCRIPTION OF PREFERRED EMBODIMENTS

A preferred embodiment reflecting an aspect of the present invention will be described in detail with reference to the drawings. However, the scope of the invention is not limited to the illustrated examples.

The preferred embodiment describes an example where an image forming apparatus of the present invention is applied to a digital Multi Function Peripheral (MFP) including a function such as copier, printer, etc.

The image forming apparatus of the present invention is not limited to a digital MFP, and may be any image forming apparatus to form an image on a sheet, such as a facsimile apparatus, an apparatus with one function such as a copier or a printer, or the like.

First, a structure of the image forming apparatus of the preferred embodiment will be described.

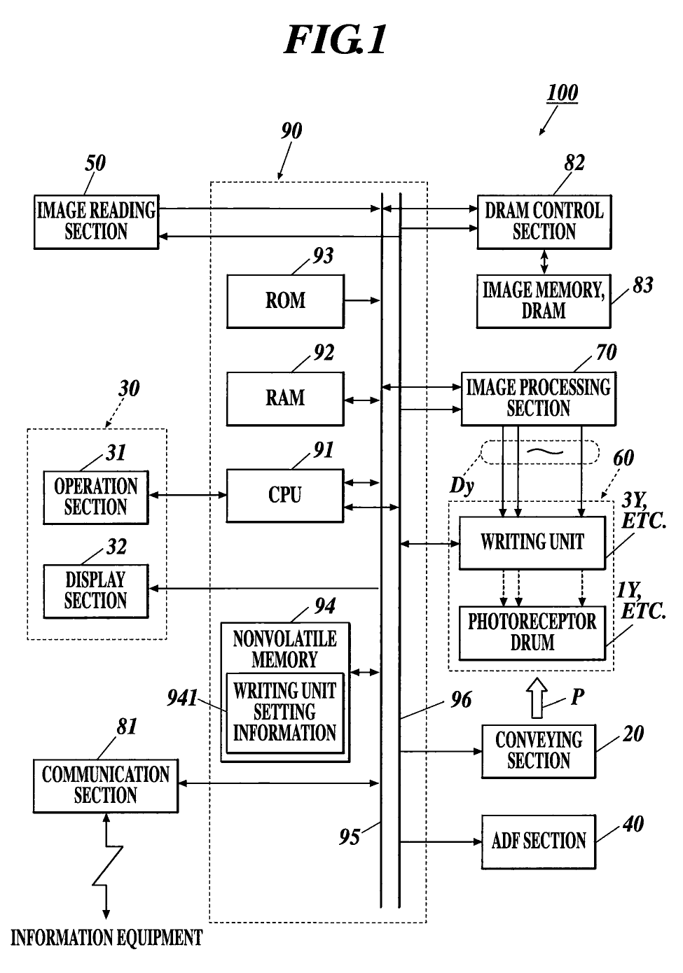

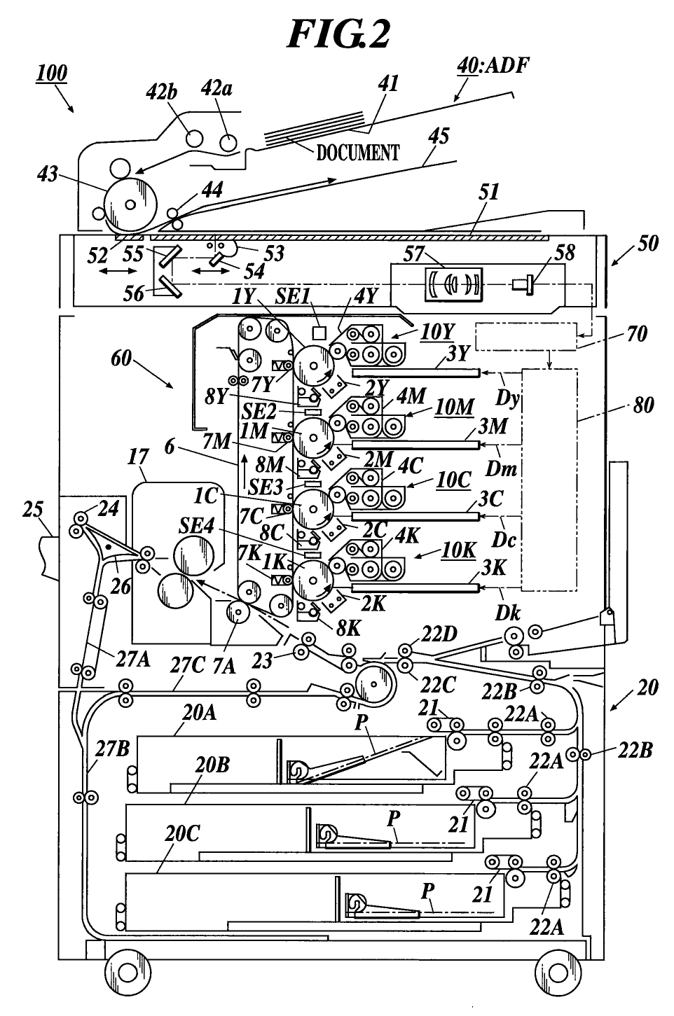

FIG. 1 is a block diagram showing a functional structure of the image forming apparatus of the preferred embodiment and FIG. 2 is an explanatory diagram showing an inner structure of the image forming apparatus.

An image forming apparatus 100 of the embodiment overlaps colors to form an image on a sheet according to image information obtained by reading a color image formed on a document or image information input from external information equipment (for example, a personal computer) through a network.

The image forming apparatus 100 includes, for example, a series of photoreceptor drums 1 (1Y, 1M, 1C and 1K) corresponding to four colors consisting of yellow (Y), magenta (M), cyan (C) and black (K), and adopts a tandem method which forms a color image on a sheet by successively transferring each color in one process.

As shown in FIG. 1, the image forming apparatus 100 includes a conveying section 20, operation/display section 30, ADF section 40, image reading section 50, image forming section 60, image processing section 70, communication section 81, DRAM control section 82, image memory 83, control section 90, and the like. Each block is electrically connected to each other by a data bus 95 and/or a control bus 96.

The control section 90 includes a CPU 91, system memory (Random Access Memory: RAM) 92, program memory (Read Only Memory: ROM) 93, nonvolatile memory 94, and the like.

The CPU 91 reads various processing programs such as a system program, image forming processing program, and the like stored in the ROM 93 and expands the program to the RAM 92 to centrally control operation of the sections of the image forming apparatus 100 according to the expanded program.

The RAM 92 forms a work area to temporarily store various programs executed by the CPU 91 and pieces of data used when the programs are executed, and stores job queue, various operation settings and the like.

The ROM 93 stores a system program compatible to the image forming apparatus 100, various processing programs such as an image forming processing program which can be executed on the system program and the like. These programs are stored in a format of a program code which can be read by the computer, and the CPU 91 successively performs operation according to the program code.

The nonvolatile memory 94 is composed of, for example, a writable/erasable semiconductor memory, and stores various setting information such as image forming condition, etc., and writing unit setting information 941 unique to each later-described writing unit 3 (3Y, 3M, 3C and 3K).

The writing unit setting information 941 is specifically information (skew correction amount, bow correction amount) to correct misalignment due to mounting status of a LED print head (LPH), which is incorporated in the writing units 3Y, 3M, 3C and 3K, to the image forming apparatus 100 or an alignment status of a plurality of LED array chips mounted on the LPH.

The conveying section 20 is provided below the image forming section 60 as shown in FIG. 2 and includes sheet trays 20A, 20B and 20C for storing a sheet to be conveyed to the image forming section 60, sending roller 21, sheet feeding roller 22A, conveying roller 22B, 22C and 22D, registration roller 23, second transfer roller 7A, and the like.

According to a sheet feeding control signal from the CPU 91, the conveying section 20, for example, conveys a sheet P from one of the sheet trays 20A, 20B or 20C to the image forming section 60.

The operation/display section 30 includes an operation section 31, display section 32, etc.

The display section 32 is composed of, for example, a liquid crystal panel (Liquid Crystal Display: LCD) and according to a display control signal from the CPU 91, displays an operation screen including a selection item, etc., concerning an image forming condition.

The operation section 31 is, for example, an operation panel composed of a plurality of operation key groups (hardware key) such as numeric key pad, start key, etc. to input the image forming condition (setting of image density, selection of sheet size, setting of number of sheets to be copied). A pressure-sensitive type (resistive film type) touch panel in which transparent electrodes are positioned in a grid-like pattern is provided on the screen of the liquid crystal panel of the display section 32, and constitutes a part of the operation section 31. The touch panel uses a voltage value to detect an X-Y coordinate of a point where force is applied by operating a finger, touch pen, etc. and outputs a detected position signal as an operation signal to the control section 90.

The ADF section 40 and the image reading section 50 are provided in an upper section of the apparatus main body.

The ADF section 40 automatically feeds one or a plurality of sheets of documents in an ADF mode (automatic document sheet feeding apparatus). Here, the ADF mode is an operation mode to automatically feed sheets of a document placed in the ADF section 40.

As shown in FIG. 2, the ADF section 40 includes a document placing section 41, roller 42a, roller 42b, roller 43, conveying roller 44 and sheet ejection tray 45. One or a plurality of sheets of a document are placed on the document placing section 41. The roller 42a and roller 42b are provided on a downstream side of the document placing section 41.

When the ADF mode is selected according to a control signal from the CPU 91, the ADF section 40 sends out the document from the document placing section 41 with the rollers 42a and 42b and conveys the document with the roller 43 at the downstream side to rotate the document in a U-shape. Then, the document is conveyed through the conveying roller 44 to be ejected to the sheet ejection tray 45. In the ADF mode, the document is placed on the document placing section 41 with a recorded side facing up.

The image reading section 50 operates to read an image formed on a document and for example, a slit-scan type scanner for color documents is used.

As shown in FIG. 1, the image reading section 50 includes a first platen glass 51, second platen glass 52 (ADF glass), light source 53, mirrors 54, 55 and 56, image forming optics section 57, image sensor 58 and reading head driving section (not shown). A reading head is composed of the light source 53, mirrors 54, 55 and 56, image forming optics section 57 and image sensor 58.

The light source 53 irradiates light on the document on the first platen glass 51 or the second platen glass 52. The reading head driving section (not shown) moves the reading head in the sub-scanning direction. Here, the sub-scanning direction is a direction orthogonal to the main scanning direction, when the main scanning direction is an alignment direction of a plurality of light-receiving elements constituting the image sensor 58.

The image sensor 58 is, for example, a three line color CCD (Charge Coupled Device) imaging apparatus and includes three reading sensors for detecting colors red (R), green (G), and blue (B) where a plurality of light-receiving elements are aligned in a main scanning direction. The reading sensors can simultaneously read light information of the colors R, G and B by separating the pixel at different positions in a sub-scanning direction orthogonal to the main scanning direction.

In the image reading section 50, for example, in the ADF mode, when the document is turned over in a U-shape by the roller 43, the light source 53 irradiates light on the surface of the document conveyed on the second platen glass 52 and the image sensor 58 forms an image of the reflected light to perform photoelectric conversion. Then, the obtained RGB-type image reading signal is output.

Also, for example, while moving the reading head in the sub-scanning direction, the light source 53 irradiates light on the surface of the document placed on the first platen glass 51 and the image sensor 58 forms an image of the reflected light to perform photoelectric conversion. Then, the obtained RGB-type image reading signal is output.

The image forming section 60 forms an image according to image data output from the image reading section 50. The RGB image data output from the image reading section 50 is converted to CMYK image data by the image processing section 80.

The image forming section 60, as shown in FIG. 2, includes image forming units 10 (10Y, 10M, 10C and 10K), a non-terminated intermediate transfer medium 6, first transfer rollers 7 (7Y, 7M, 7C and 7K), sensors SE1, SE2, SE3 and SE4, fixing device 17 and the like.

The image forming units 10 (10Y, 10M, 10C and 10K) for forming an image of each color (Y, M, C and K) each include a photoreceptor drum 1 (1Y, 1M, 1C and 1K) as an image forming medium to form a toner image of each color, charging section 2 for each color placed around the photoreceptor drum 1 (2Y, 2M, 2C and 2K), writing unit 3 (3Y, 3M, 3C and 3K), developing section 4 (4Y, 4M, 4C and 4K) and cleaning section 8 (8Y, 8M, 8C and 8K).

The charging section 2 and the writing unit 3 form a latent image on the intermediate transfer medium 6. As the writing unit 3, the LPH (LED Print Head) is used where light-emitting elements (LED) are aligned for forming an image in a line in a main scanning direction which is orthogonal to a conveying direction (sub-scanning direction) of a sheet on which an image is to be formed. The LPH is a plurality of LED array chips, which is formed with a plurality of LEDs by a semiconductor process, mounted on a substrate along an ideal alignment line.

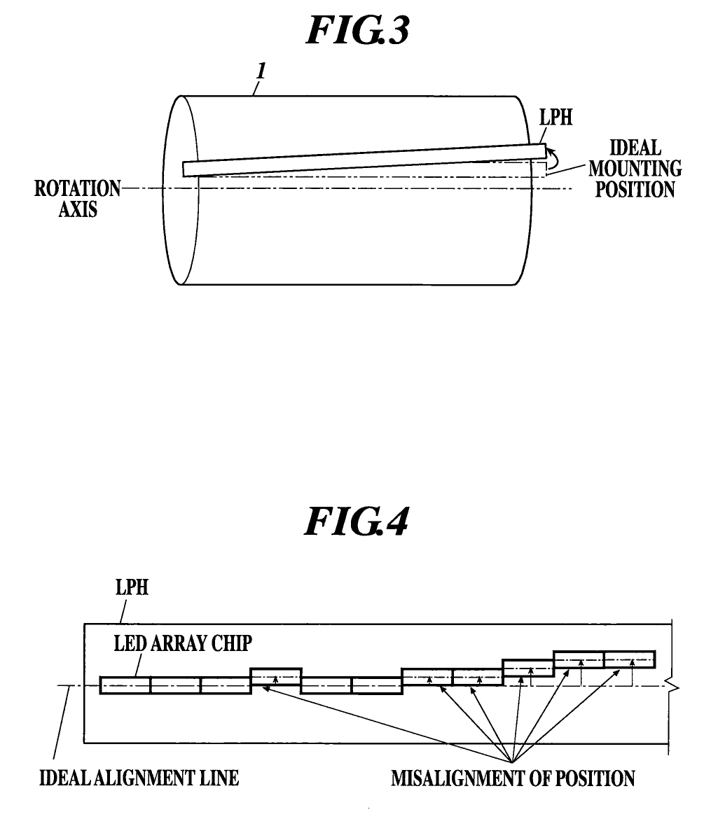

Here, the LPH is mounted parallel to the rotation axis (main scanning direction) of the photoreceptor drum 1. However, specifically, the LPH is in a diagonally right up or a diagonally right down status compared to the ideal mounting position, and is not always parallel to the main scanning direction (See FIG. 3). When the LPH is tilted compared to the main scanning direction as shown here, the printing quality of the image forming apparatus 100 reduces, therefore, a suitable correction processing is performed in the later-described image processing section 80 (skew correction).

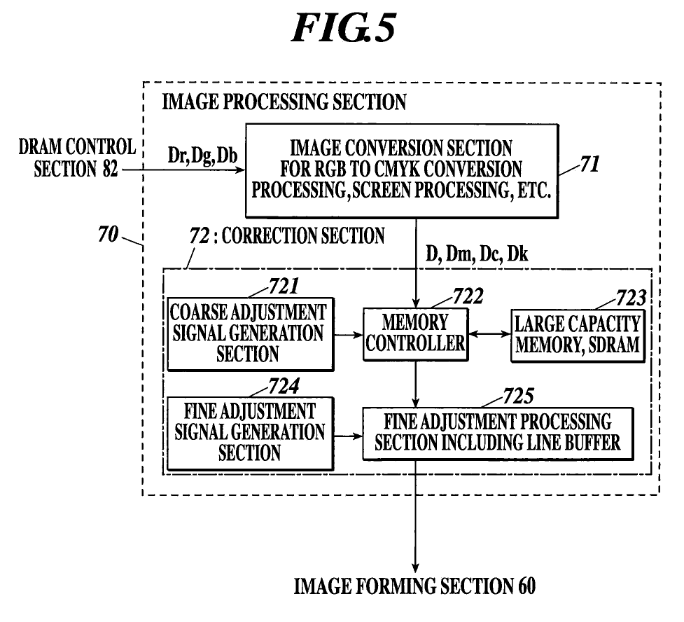

Also in the LPH, it is ideal that the LED array chips are aligned in one straight line, however actually some variation in the mounting of each LED array chip occurs (See FIG. 4). In this case also, the printing quality of the image forming apparatus 100 decreases, therefore a suitable correction processing is performed in the later-described image processing section 80 (bow correction).

The correction amount used in performing skew correction and bow correction is stored in the above-described nonvolatile memory 94 as writing unit setting information 941.

The developing section 4 performs developing by a reversal development which applies a developing bias which is an alternating voltage combined to a direct voltage having the same polarity (for example, negative polarity) as the polarity of the toner used.

The cleaning section 8 collects residual transferred toner remaining on the surface of the photoreceptor drum 1 with a charged brush, rubber blade, or the like.

The intermediate transfer medium 6 is rotated by a plurality of rollers, supported rotatably and toner images of the colors Y, M, C and K formed on each photoreceptor drum 1Y, 1M, 1C and 1K respectively are transferred.

The first transfer roller 7 transfers images of each color formed on the image forming units 10 on the intermediate transfer medium 6 by applying a first transfer bias having an opposite polarity (for example, positive polarity) of the toner used.

The sensors SE1, SE2, SE3 and SE4 are, for example constituted by optical sensors and are provided above the photoreceptor drums 1Y, 1M, 1C and 1K. The sensors SE1, SE2, SE3 and SE4 are provided in a line in a main scanning direction at a position about a maximum width of the developing performed by the developing sections 4Y, 4M, 4C and 4K, and the sensors detect the adhesion status of the toner when developed in the main scanning direction at the maximum width to output the detection signal to a later-described control section 70. In other words, the sensors SE1, SE2, SE3 and SE4 detect the maximum width (writable maximum width) of the developing in the main scanning direction by the developing sections 4Y, 4M, 4C and 4K.

The sensors SE1, SE2, SE3 and SE4 not only detect the writable maximum width, but are also provided in a predetermined position in the main scanning direction and detect the difference between the designed resolution and the actual resolution by detecting misalignment of a predetermined pattern image formed by the developing section 4Y, 4M, 4C and 4K to output the detection signal to the control section 70.

The fixing device 17 fixes the toner image transferred from the intermediate transfer medium 6 to the sheet by applying heat or heat and pressure.

In the image forming section 60, each LPH of the writing unit 3 exposes one line of the photoreceptor drum 1 charged by the charging section 2 at once and forms an electrostatic latent image in a line in the main scanning direction.

The electrostatic latent image in a line formed on the photoreceptor drum 1 is developed as toner images of each color by the developing section 4.

Then, the toner images of each color formed by the developing section 4 are successively transferred on the rotating intermediate transfer medium 6 by the first transfer roller 7 and the colors are overlapped and combined to form a color image (color toner image) (first transfer).

The sheet P stored in sheet tray 20A, etc. is fed by the sending roller 21 and sheet feeding roller 22A provided for the sheet tray 20A, etc. and is conveyed through the conveying roller 22B, 22C and 22D, registration roller 23, etc., to the second transfer roller 7A. Then, on one side of the sheet P (for example, top side) the color image is transferred at once from the intermediate transfer medium 6 (second transfer).

After the color image is transferred on the sheet P, heat fixing processing by the fixing device 17 is performed on the sheet P, and the sheet P is nipped by the sheet ejection roller 24 to be ejected on the sheet ejection tray 25 outside the apparatus.

When images are formed on both sides of the sheet, after an image is formed on one side (for example, top side), the sheet P ejected from the fixing device 17 diverges from the sheet ejection path by a branching section 26. Next, the sheet P passes through a sheet rotation path 27A located below, and the top and bottom of the sheet P is turned over by a reversal conveying path 27B which is a sheet refeeding mechanism (ADU mechanism). Then, the sheet P passes through the refed sheet conveying section 27C to join the above-described transferring path from the conveying roller 22D. The sheet P conveyed turned over passes the registration roller 23 to be conveyed to the second transfer roller 7A again, and the color image is transferred at once on the other side (bottom side) of the sheet P.

The image processing section 70 performs analog processing, A/D conversion, shading correction, image compression processing, variable magnification processing, etc. to the analog image reading signal output from the image reading section 50 to generate digital image data with RGB components. The generated image data is stored in the later-described image memory 83.

When image forming processing is performed in the image forming section 60, the image processing section 70 converts RGB image data Dr, Dg and Db to CMYK image data Dy, Dm, Dc and Dk and also performs skew correction and/or bow correction on the CMYK image data to output corrected image data to the writing unit 3. The correction processing is described below.

The communication section 81 is a communication interface to connect to a communication network such as a Local Area Network (LAN) and sends and receives data between external equipment such as a personal computer through a network. For example, when the communication section 81 receives a print job (including image data) sent from the external equipment, the CPU 91 controls the image forming section 60 according to the received print job and allows the image forming section 60 to perform the image forming processing.

Based on control from the CPU 91, the DRAM control section 82 performs access control when the image data is read or written in the image memory 83. For example, image data input from the image reading section 50 or image data input from external information equipment through the communication section 81 are stored in the image memory 83.

The image memory 83 is composed of, for example, a storage medium such as a DRAM. The image memory 83 includes a compressed memory area and page memory area, and stores image data which is a source of the image formed in the image forming section 60.

The image forming apparatus 100 of the embodiment has the above-described structure.

Next, the image processing (correction processing) in the image processing section 70 will be described in detail.

FIG. 5 is an explanatory diagram showing a specific structure of the image processing section 70. Incidentally, among components of the image processing section 70, FIG. 5 shows components used in image forming, and thus components used when image data is input from the image reading section 50 and external information equipment are omitted (for example, analog processing section, A/D conversion section, etc.).

As shown in FIG. 5, the image processing section 70 includes an image conversion section 71 and correction section 72.

The image conversion section 71 includes a memory (not shown) to store information concerning color conversion such as a three-dimensional color information conversion table, etc., and converts input image data of RGB components (Dr, Dg and Db) to image data Dy, Dm, Dc and Dk of Y, M, C and K components by referring to the three-dimensional color information conversion table. Also, the image conversion section 71 performs screen processing, etc. to output gray-scale density beautifully and stably.

The correction section 72 includes a coarse adjustment signal generation section 721, memory controller 722, large capacity memory 723, fine adjustment signal generation section 724, fine adjustment processing section 725 and the like. FIG. 5 is simplified, and the correction sections 72 are provided corresponding to each writing unit 3Y, 3M, 3C and 3K, and in each correction section 72, correction is performed according to the writing unit setting information 941 unique to each writing unit.

The coarse adjustment signal generation section 721 generates a coarse adjustment enable signal according to the writing unit setting information 941 stored in the nonvolatile memory 94. The coarse adjustment enable signal is a signal to instruct the address when the memory controller 722 writes image data in the large capacity memory 723 or reads image data from the large capacity memory 723.

The large capacity memory 723 is a memory which can perform burst transfer and is composed of, for example, a synchronous DRAM (SDRAM) or DDR_SDRAM.

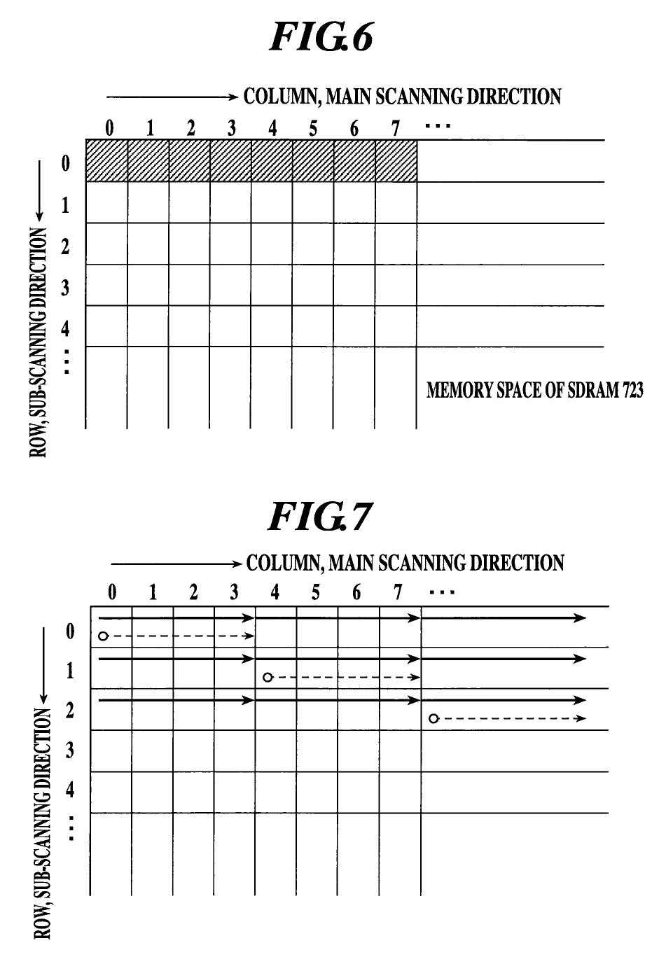

FIG. 6 is a conceptual diagram showing a memory space of a large capacity memory 723.

As shown in FIG. 6, the large capacity memory 723 includes a two-dimensional address called a column address and row address. In burst transfer, when the column address and the row address are specified, data is successively written or read in the column direction from the cell and fast transfer is realized. Here, the column address is automatically incremented.

For example, when transferring is performed with row address=0, column address=0, and burst length (number of bits which can be transferred at once)=8, data is written at once in the hatched area of the memory space shown in FIG. 6 or the data in the hatched area is read at once.

In the embodiment, the image data per pixel is stored in a corresponding cell in the large capacity memory 723 with the main scanning direction of the image matching the column address and the sub-scanning direction of the image matching the row address. In other words, although not exactly the same, it is as if an output image is formed in the memory space.

In the burst transfer in the large capacity memory 723, transfer of image data is performed at a predetermined burst access unit (burst transfer unit). The burst access unit is determined by specification of the large capacity memory 723 (burst length, data bus width, etc.). For example, in a large capacity memory 723 with a burst length=8 and data bus width=16 bit, the burst access unit is 128 bit.

The data block when burst transfer is performed can be suitably changed according to the burst access unit. For example, when the burst length=8 and the data bus width=16 bit, a transfer unit can be a pixel group of 128 pixels×1 line or the transfer unit can be a pixel group of 32 pixels×4 lines.

The memory controller 722 performs access control when image data is read or written in the large capacity memory 723 according to the coarse adjustment enable signal generated by the coarse adjustment signal generation section 721. The control processing (correction processing) of the memory controller 722 is called the coarse correction.

For example, by successively writing the image data throughout the main scanning direction sent by the image conversion section 71 to the large capacity memory 723, and controlling the address when the image data is read from the large capacity memory 723, the pixel position of the image formed can be shifted in the sub-scanning direction.

FIG. 7 is a conceptual diagram showing address control when burst transfer (burst-reading) is performed in the large capacity memory 723. FIG. 7 shows a case where data is transferred with a burst access unit of 4 pixels×1 line, and data writing is shown with a solid arrow and data reading is shown with a dotted arrow.

As shown in FIG. 7, the data writing is performed successively per line. In other words, one line of image data is stored in one line of the large capacity memory 723 (cell of the same row address). On the other hand, when data is read, the data is read while changing the row address of the large capacity memory 723 according to amount of misalignment (writing unit setting information 941). FIG. 7 shows after four cells are read in the main scanning direction (column address=0 to 3, row address=0), one is incremented in the row address and four cells of the next line (column address=4 to 7, row address=1) are read. In other words, one line of image data input to the LPH is actually composed of image data of a line shifted in the sub-scanning direction.

The address can be controlled (for example, writing with the row address shifted) when the image data sent from the image conversion section 71 is burst-written on the large capacity memory 723. When image data written in this way is successively read out per line, the pixel position of where the image is formed is shifted in the sub-scanning direction.

When a predetermined number of lines of image data is a burst access unit, the memory controller 722 transfers one block line of image data throughout the main scanning direction in this burst access unit, in other words, transfers the predetermined number of lines of image data.

As described above, the tilt (skew) or the like caused by the mounting status of the LPH can be roughly corrected by controlling the address (coarse adjustment correction) when reading or writing is performed in the large capacity memory 723. As shown in FIG. 7, when the image data is read, one-fourth of the tilt is corrected by the coarse adjustment correction.

However, the transfer from the large capacity memory 723 is performed in the burst access unit, therefore, the reading position of the image data cannot always be corrected in the pixel unit in the main scanning direction. Therefore, the reading position of the image data in the pixel unit in the main scanning direction is corrected in the later-described fine adjustment processing section 725.

The fine adjustment signal generation section 724 generates fine adjustment enable signal based on the writing unit setting information 941 stored in the nonvolatile memory 94. The fine adjustment enable signal is a signal to select image data to be output among the image data stored in the plurality of stages of line buffers in the fine adjustment processing section 725.

The fine adjustment processing section 725 is configured including a plurality of stages of line buffers and the line buffers store image data throughout the main scanning direction sent in the burst access unit from the memory controller 722. Then, the fine adjustment processing section 725 reads data from a predetermined address of the line buffer based on the fine adjustment enable signal generated by the fine adjustment signal generation section 724. The correction processing in the fine adjustment processing section 725 is called the fine adjustment correction.

Therefore, in the fine adjustment correction, the number of pixels which can be corrected in the sub-scanning direction is determined by the number of stages of the line buffer. For example, when the number of stages of the line buffer is M and one line of image data is stored in one line buffer, a tilt of 1/M can be corrected by this fine adjustment correction.

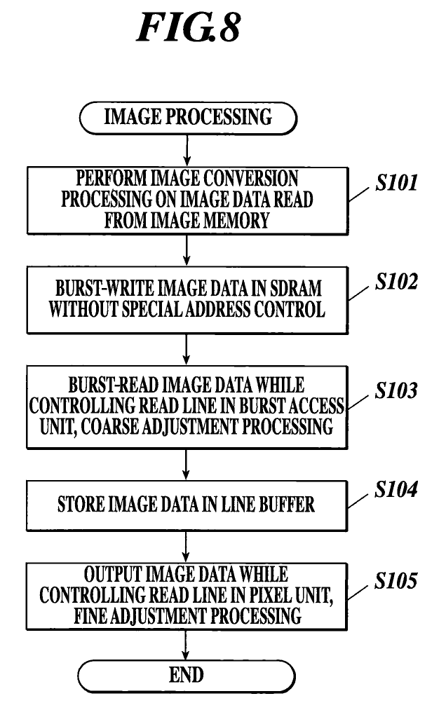

FIG. 8 is a flowchart showing a correction processing of the image processing section 70.

In step S101, image conversion processing such as color conversion processing, etc. is performed in the image conversion section 71 on image data read per line from the image memory 83 by the DRAM control section 83.

In step S102, burst-writing of the image data input from the image conversion section 71 to the large capacity memory 723 is performed by the memory controller 722. The writing processing does not perform control of the writing line and successively writes each line of the input image data.

In step S103, burst-reading (coarse adjustment processing) of image data from the large capacity memory 723 is performed while controlling the read line in a burst access unit by the memory controller 722. Specifically, the read line is controlled in the burst access unit according to the coarse adjustment enable signal from the coarse adjustment signal generation section 721.

In step S104, the image data transferred in the burst access unit from the memory controller 723 is stored in a line unit in the line buffer of the fine adjustment processing section 725.

In step S105, image data is read from the line buffer to be output to the writing unit 3Y, etc., while controlling the read line in the pixel unit in the main scanning direction by the fine adjustment processing section 725 (fine adjustment processing). Specifically, the read line is controlled in pixel unit according to the fine adjustment enable signal from the fine adjustment signal generation section 741.

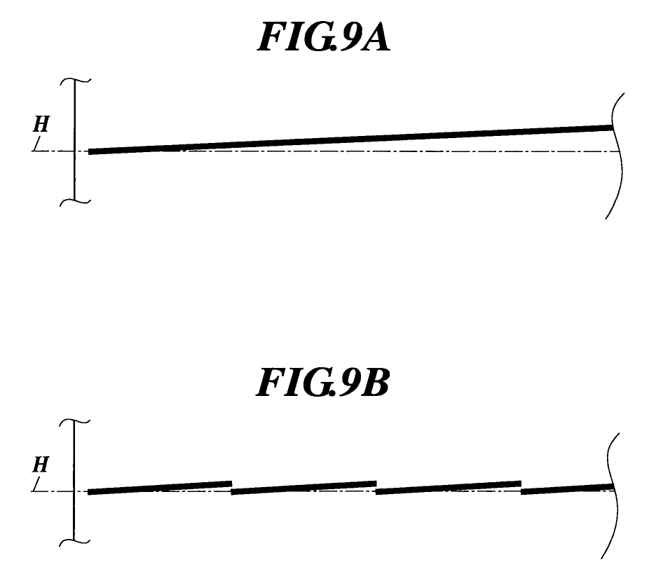

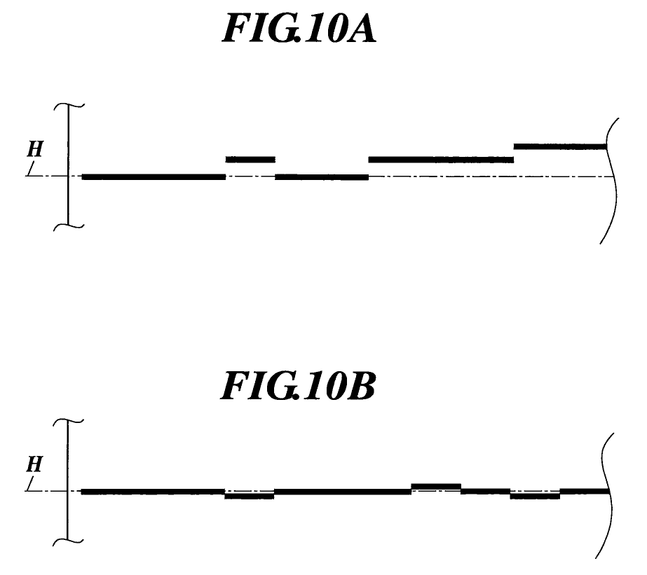

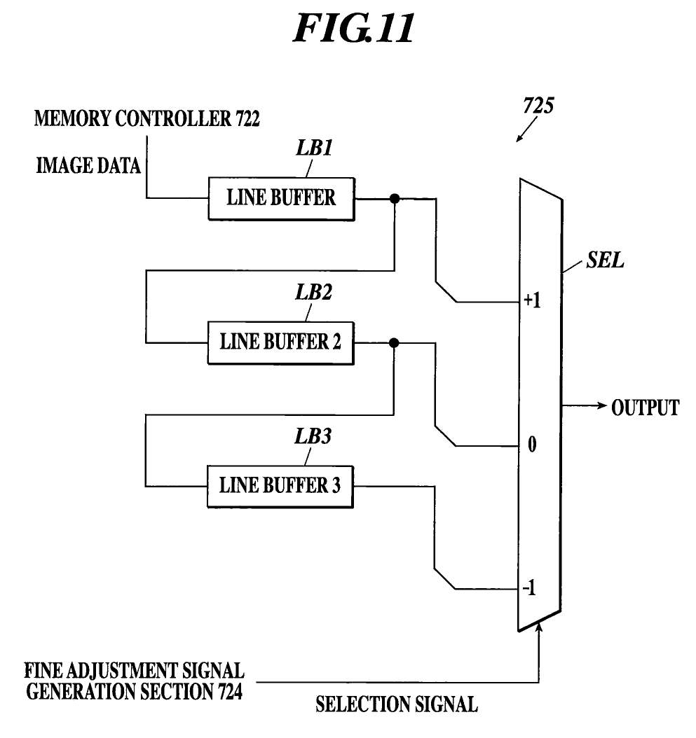

According to the coarse adjustment processing and the fine adjustment processing, the position where the image is formed is corrected and printing misalignment such as skew, bow, etc., can be resolved (See FIG. 9A, FIG. 9B, FIG. 10A and FIG. 10B). Incidentally, in the writing unit 3, the LPH driver changes the order of the image data sent successively in the main scanning direction to an order which can be interpreted by the LPH and forms an electrostatic latent image on the photoreceptor drum 1Y, etc. by exposing the LPH.

As described above, the image forming apparatus 100 includes, an image memory 83 to store image data to form an image composed of a plurality of pixels aligned in a main scanning direction and a sub-scanning direction; a print head (LPH) to form an image on a sheet based on the image data; and a correction section 72 to perform correction processing on the image data read from the image memory 83 to correct misalignment (skew/bow) which occurs when an image is formed due to mounting status of the print head or alignment status of a light-emitting element of the print head.

The correction section 72 includes, a memory (large capacity memory) 723 which can perform burst transfer, to store image data per pixel read from the image memory with the main scanning direction of the image corresponding to a column address and the sub-scanning direction of the image corresponding to a row address; a first control section (memory controller) 722 to perform address control when data is transferred in the memory 723; a plurality of stages of line buffers (fine adjustment processing section) 725 to store image data throughout the main scanning direction transferred in burst access unit from the memory 723; and a second control section (fine adjustment processing section 725) to select image data to output per main scanning coordinate among a plurality of lines of image data stored in the plurality of stages of line buffers.

The first control section (memory controller) 722 successively writes in the burst access unit the image data per pixel in the memory (large capacity memory) 723 and reads the image data per pixel in the burst access unit while controlling the address of the memory 723 according to a first control signal (coarse adjustment enable signal) generated based on previously set information (writing unit setting information) 941 concerning correction to transfer to the line buffer (fine adjustment processing section) 725.

The second control section (fine adjustment section) 725 selects image data to output per main scanning coordinate among the plurality of lines of image data stored in the plurality of stages of line buffers according to a second control signal (fine adjustment enable signal) generated based on the information concerning correction.

As described above, according to the image forming apparatus 100 of the embodiment, the image forming apparatus 100 is an image forming apparatus which can correct misalignment (skew/bow) in image forming due to mounting status of a print head or an alignment status of a light-emitting element of the print head, which can easily adapt to increase of image forming ability (higher resolution) and reduce cost of the apparatus.

In other words, in the image forming apparatus 100, after the memory controller 722 controls the read line in the burst access unit by the coarse adjustment processing, the fine adjustment processing section 725 controls the read line in the pixel unit by the fine adjustment processing and therefore, there is no need to have a line buffer with the total maximum correction amount throughout the main scanning direction. Consequently, the amount of RAM of the line buffer can be reduced and thus the cost of the apparatus can be reduced.

Further, the image forming apparatus 100 of the embodiment includes a series of photoreceptor drums 1Y, 1M, 1C and 1K of a plurality of colors and is a tandem-type image forming apparatus which forms a color image on a sheet by successively transferring each color in one process.

The timing of forming an image of each color can be adjusted (color shift correction) by using the above-described large capacity memory 723. The color drift correction is performed by the memory controller 722.

In other words, in the image conversion section 71 shown in FIG. 5, the image processing is performed while observing the relation between the colors, and therefore, the pieces of image data Dy, Dm, Dc and Dk of each color are input to the memory controller 722 at the same timing.

On the other hand, the timing of lighting of the light-emitting element of the LPH depend on the relation of the position between the photoreceptor drum 1 and the intermediate transfer medium 6, and this is different for each writing unit 3. For example, as shown in FIG. 2, the photoreceptor drum 1K for the color K is provided at the subsequent stage in the running direction of the intermediate transfer medium 6 than the photoreceptor drum 1Y for the color Y, therefore, the timing of turning on the LPH needs to be delayed in order to overlap the toner image.

Therefore, the large capacity memory 723 is used like a vast line buffer for adjusting timing (color shift correction) and the toner images of each color are overlapped by each writing unit 3.

The above-described color shift correction is a publicly-known technique realized in conventional image forming apparatuses. In other words, in the image forming apparatus 100 of the embodiment, the large capacity memory 723, which has been conventionally used for color shift correction, is used for the coarse adjustment processing of the skew/bow. Consequently, there is no need to newly provide a large capacity memory 723 for the coarse adjustment correction, and thus realizing the present invention does not involve a rise in the cost of the apparatus.

Below, examples of correction processing are described, using the above-described image forming apparatus 100 when the setting of the burst transfer of the large capacity memory 723 is burst length=8, data bus width=16 bit, in other words, the burst access unit is 8×16=128 bit.

### FIRST EXAMPLE

In the first example, correction of skew due to the mounting status of the LPH is described where the transfer processing of the large capacity memory 723 by the memory controller 722 is performed in the burst access unit of 128 pixels'1 line.

FIG. 11 is an explanatory diagram showing an example of a specific structure of a fine adjustment processing section 725 used in the first example.

The fine adjustment processing section 725 shown in FIG. 11 includes three stages of line buffers LB1 to LB3 and selector SEL.

The line buffer LB1 stores image data burst transferred as (N+1)-th line from the memory controller 722. The line buffer LB2 stores image data burst transferred as N-th line from the memory controller 722. The line buffer LB3 stores image data burst transferred as (N−1)-th line from the memory controller 722.

According to a selection signal (fine adjustment enable signal) from the fine adjustment signal generation section 724, the selector SEL selects which image data is to be output data among three lines of image data transferred from the memory controller 722. Here, the output signals from the line buffers LB1 to LB3 are synchronized by a main scanning synchronization signal (not shown), therefore output of the image data corresponding to the pixel of the same main scanning coordinate can be selected among the three pixels adjacent in the sub-scanning direction.

In other words, in the line buffer shown in FIG. 11, three lines of image data can be stored, and the output image data can be selected among the data per pixel in the main scanning direction, therefore the image can be shifted +one line in the sub-scanning direction by the fine-adjustment processing.

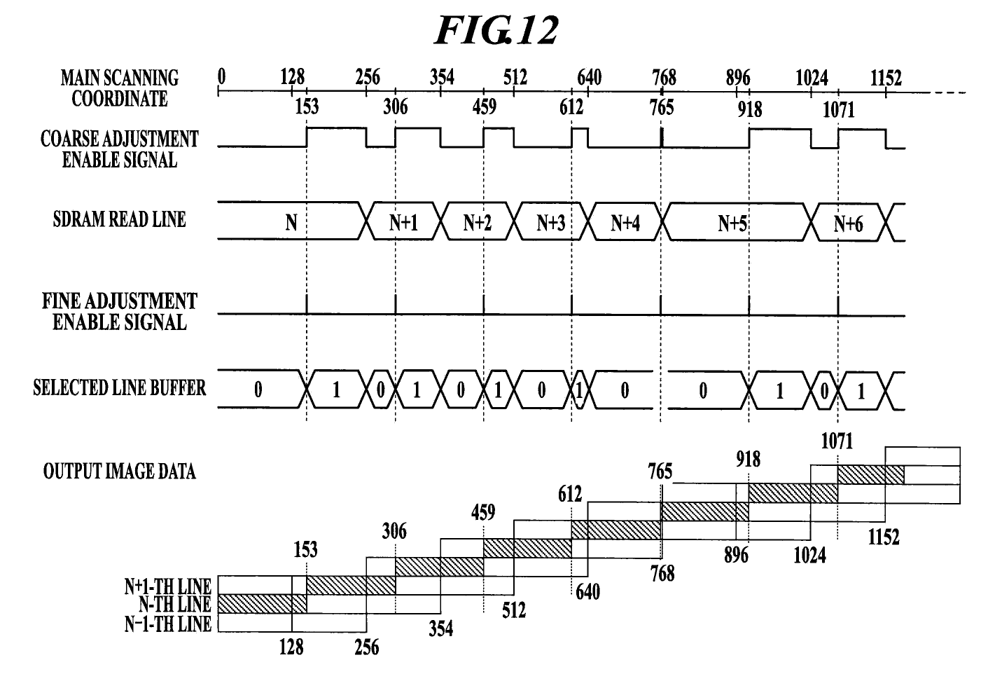

FIG. 12 is a timing chart showing an example of correction processing of the first example and an explanatory diagram showing an image of output image data.

FIG. 12 shows a case of skew correction where an end of the LPH is delayed 100 lines (in FIG. 3, the LPH is tilted diagonally right up 100 lines) when using the LPH with a resolution of 1200 dpi. In other words, in the LPH with the resolution of 1200 dpi, number of pixels throughout the main scanning direction=15360 pixels, 15360/100=153.6 (pixels), and this number is rounded to 153 pixels, therefore, the skew correction forms an image in a stair-like pattern for every 153 pixels.

The image data per pixel is successively written in burst access unit (128 pixels×1 line) in the large capacity memory 723. In other words, in FIG. 12, coarse adjustment processing is performed by address control when image data is read from the large capacity memory 723.

As shown in FIG. 12, the coarse adjustment signal generation section 721 generates a coarse adjustment enable signal for every 153 pixels which increments the read address (row address) to output the signal to the memory controller 722.

As shown in FIG. 12, according to the coarse adjustment enable signal, the memory controller 722 reads the image data per pixel in burst access unit while controlling the address of the large capacity memory 723 to transfer to the line buffer.

Specifically, in the large capacity memory 723, the N-th line is the read line up to 256-th pixel of the main scanning coordinate, the (N+1)-th line is the read line from 256-th pixel to 384-th pixel of the main scanning coordinate, and the (N+2)-th line is the read line from 384-th pixel to 512-th pixel. Here, the memory controller 722 latches the coarse adjustment enable signal to the timing of the burst transfer and changes the read line at the timing of a falling edge. With this, the address control can be performed in burst access unit.

As shown in FIG. 12, the fine adjustment signal generation section 724 generates a fine adjustment enable signal for every 153 pixels which increments the read address (read line of the line buffer) to output to the fine adjustment processing section 725.

As shown in FIG. 12, according to the fine adjustment enable signal, the selector SEL of the fine adjustment processing section 725 selects a line buffer to read the image data. Specifically, the selector SEL selects, up to 153-rd pixel of the main scanning coordinate, the output 0 of the line buffer (line buffer LB2 shown in FIG. 11), from 153-rd pixel to 256-th pixel of the main scanning coordinate, the output+1 (line buffer LB1 shown in FIG. 11), and so on. In other words, with the fine adjustment processing, correction can be performed in ±1 pixels in the sub-scanning direction throughout the main scanning coordinate. The line buffer output 0 is selected at the timing when the read line of the large capacity memory 723 is changed according to the coarse adjustment enable signal.

As shown in FIG. 12, according to the above-described correction processing, the image data is delayed by one line for every 153 pixels to be output. In other words, for example, an image of one straight line in the main scanning direction is formed tilted diagonally right down from the main scanning direction, therefore, this balances out the tilt of the LPH and as a result, an image of one straight line in the main scanning direction is formed (strictly not one straight line, but is negligible when seen by a human eye).

In the first example the burst access unit of the large capacity memory 723 is 128 pixels×1 line and has three stage of line buffers, therefore a tilt of 1/128 or less can be corrected by the correction processing.

In order to correct a skew as shown in the first example in a conventional image forming apparatus, a hundred stages of line buffers needed to be provided. On the other hand, with the image forming apparatus 100 of the embodiment, fine adjustment processing is performed after coarse adjustment processing is performed, therefore, correction can be performed by providing only three stages (or three stages or less) of line buffers. Therefore, an image forming apparatus which can easily adapt to increase of image forming ability (higher resolution) and where cost of the apparatus can be reduced can be realized.

### SECOND EXAMPLE

In the second example, correction of skew due to the mounting status of the LPH is described where the transfer processing of the large capacity memory 723 by the memory controller 722 is performed in the burst access unit of 32 pixels×4 lines.

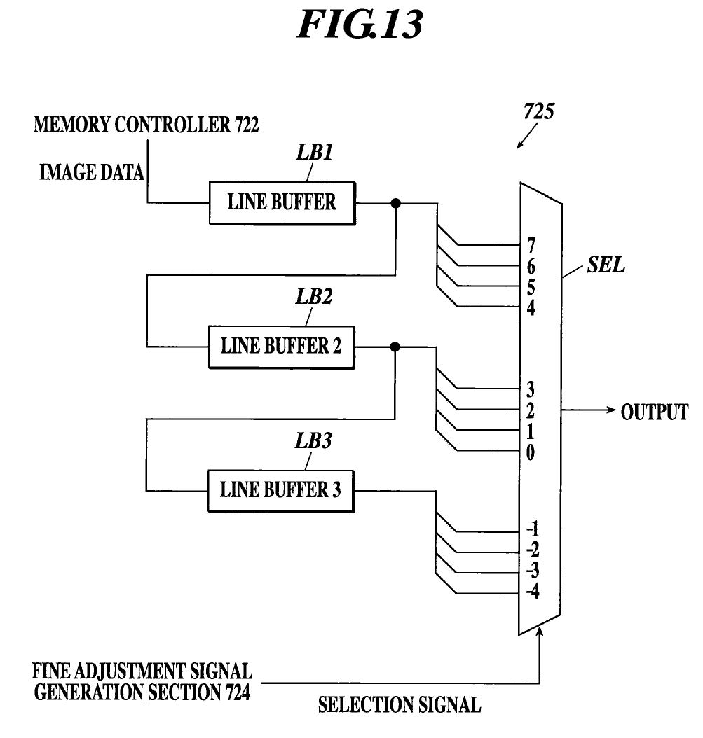

FIG. 13 is an explanatory diagram showing an example of a specific structure of a fine adjustment processing section 725 used in the second example.

The fine adjustment processing section 725 shown in FIG. 13 includes three stages of line buffers LB1 to LB3 and selector SEL. The image data throughout the main scanning direction transferred in the burst access unit of 32 pixels×4 lines (hereinafter referred to as one block line) is stored in each line buffer. In other words, the difference from the first example is that four lines of the original image data are stored in one line buffer.

The line buffer LB1 stores image data burst transferred as (N+1)-th block line from the memory controller 722. The line buffer LB2 stores image data burst transferred as N-th block line from the memory controller 722. The line buffer LB3 stores image data burst transferred as (N−1)-th block line from the memory controller 722.

According to a selection signal (fine adjustment enable signal) from the fine adjustment signal generation section 724, the selector SEL selects which image data is to be output data among three block lines of image data transferred from the memory controller 722. Here, the output signals from the line buffers LB1 to LB3 are synchronized by a main scanning synchronization signal (not shown), therefore output of the image data corresponding to the four pixels of the same main scanning coordinate can be selected among the twelve pixels adjacent in the sub-scanning direction.

In other words, in the line buffer shown in FIG. 13, twelve lines of image data can be stored, and the output image data (four pixels of image data adjacent in the sub-scanning direction) can be selected among the data per pixel in the main scanning direction, therefore the image can be shifted ± four lines in the sub-scanning direction by the fine adjustment processing.

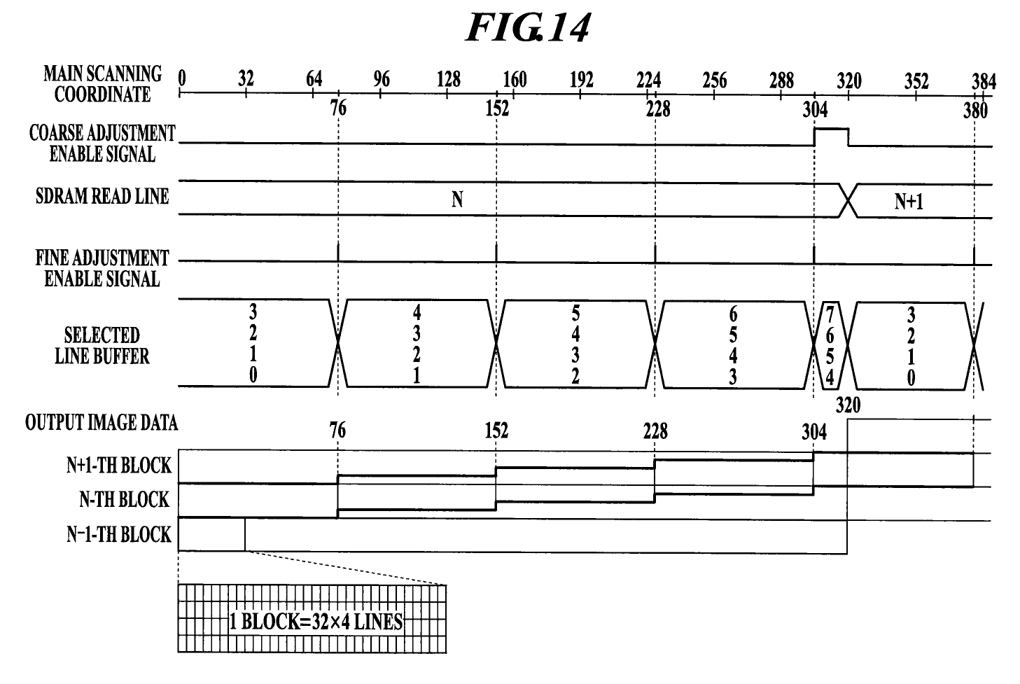

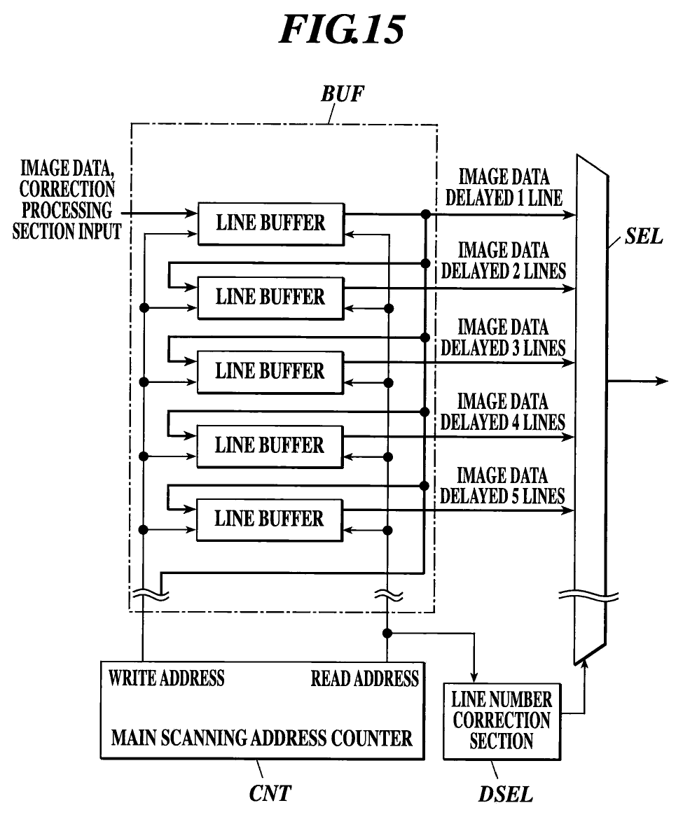

FIG. 14 is a timing chart showing an example of correction processing of the second example and an explanatory diagram showing an image of output image data.

FIG. 14 shows a case of skew correction where an end of the LPH is delayed 100 lines (in FIG. 3, the LPH is tilted diagonally right up 100 lines) when using the LPH with a resolution of 600 dpi. In other words, in the LPH with the resolution of 600 dpi, number of pixels throughout the main scanning direction=7680 pixels, 7680/100=76.8 (pixels), and this number is rounded to 76 pixels, therefore, the skew correction forms an image in a stair-like pattern for every 76 pixels.

The image data per pixel is successively written in the burst access unit (32 pixels×4 lines) in the large capacity memory 723. In other words, in FIG. 14, coarse adjustment processing is performed by address control when image data is read from the large capacity memory 723.

As shown in FIG. 14, the coarse adjustment signal generation section 721 generates a coarse adjustment enable signal for every 304 pixels which increments the read address (row address) to output the signal to the memory controller 722.

As shown in FIG. 14, according to the coarse adjustment enable signal, the memory controller 722 reads the image data per pixel in the burst access unit while controlling the address of the large capacity memory 723 to transfer to the line buffer.

Specifically, in the large capacity memory 723, the N-th line block is the read line block up to 320-th pixel of the main scanning coordinate, the (N+1)-th line block is the read line block from 320-th pixel or more of the main scanning coordinate, and so on. Here, the memory controller 722 latches the coarse adjustment enable signal to the timing of the burst transfer and changes the read line at the timing of a falling edge. With this, the address control can be performed in the burst access unit.

As shown in FIG. 14, the fine adjustment signal generation section 724 generates a fine adjustment enable signal for every 76 pixels which increments the read address (read line of the line buffer) to output to the fine adjustment processing section 725.

As shown in FIG. 14, according to the fine adjustment enable signal, the selector SEL of the fine adjustment processing section 725 selects four adjacent pixels of image data as output data among the twelve adjacent pixels of image data in the sub-scanning direction stored in the line buffer. Specifically, the selector SEL selects, up to 76-th pixel of the main scanning coordinate, the output 0, 1, 2, 3 of the line buffer (output from line buffer LB2 shown in FIG. 13), from 76-th pixel to 152-nd pixel of the main scanning coordinate, the output 1, 2, 3, 4 of the line buffer (output 1, 2, 3 from line buffer LB2 and output 4 from line buffer LB1 shown in FIG. 13), and so on. In other words, with the fine adjustment processing, correction can be performed in ±4 pixels in the sub-scanning direction throughout the main scanning coordinate. The line buffer output 0, 1, 2, 3 is selected at the timing when the read line of the large capacity memory 723 is changed according to the coarse adjustment enable signal.

As shown in FIG. 14, according to the above-described correction processing, the image data is delayed by one line for every 76 pixels to be output. In other words, for example, an image of one straight line in the main scanning direction is formed tilted diagonally right down from the main scanning direction, therefore, this balances out the tilt of the LPH and as a result, an image of one straight line in the main scanning direction is formed (strictly not one straight line, but is negligible when seen by a human eye).

In the second example, the burst access unit of the large capacity memory 723 is 32 pixels×4 lines and has three stages of line buffers, therefore a tilt of 4/32 or less can be corrected by the correction processing.

In order to correct a skew as shown in the second example in a conventional image forming apparatus, a hundred stages of line buffers needed to be provided. On the other hand, with the image forming apparatus 100 of the embodiment, fine adjustment processing is performed after coarse adjustment processing is performed, therefore, correction can be performed by providing only three stages (or three stages or less) of line buffers. Therefore, an image forming apparatus which can easily adapt to increase of image forming ability (higher resolution) and where cost of the apparatus can be reduced can be realized.

As described above, in the second example, address control is performed when data is transferred in the large capacity memory 723 with a predetermined number of lines of image data as the burst access unit. Also, the plurality of stages of line buffers configuring the fine adjustment processing section 725 are each configured to be able to store a predetermined number of lines of image data. Then, the fine adjustment processing section 725 selects a predetermined number of lines of image data per main scanning coordinate (for example, four pixels of image data adjacent in the sub-scanning direction).

With this, the correction amount which can be performed can be easily increased. In other words, by suitably changing the burst access unit when data is transferred in the large capacity memory 723 and the status of the line buffer (number of stages, number of lines of image data each stage can store, etc.), the skew due to mounting status of the LPH can be easily corrected. This is especially effective when resolution of image data significantly increases in the future.

Examples of the preferred embodiment have been described, however, the present invention is not limited to the above-described embodiments and may be suitably modified within the scope of the present invention.

For example, in the above-described embodiment, the address control when data is transferred in the large capacity memory 723 is performed in burst-reading, however, the address control can be performed in burst-writing.

In other words, when a first control section (memory controller) 722 writes image data per pixel in burst access unit while controlling the address of a memory (large capacity memory) 723 according to a first control signal (coarse adjustment enable signal) generated based on previously set information concerning correction (writing unit setting information) 941, the written image data is successively read in burst access unit and transferred to a line buffer (fine adjustment processing section) 725.

The second control section (fine adjustment processing section) 725 selects image data to output with respect to each main scanning coordinate among the plurality of lines of image data stored in the plurality of stages of line buffers according to a second control signal (fine adjustment enable signal) generated based on information concerning correction.

With this, an image forming apparatus which can correct misalignment (skew/bow) in image forming due to mounting status of a print head or an alignment status of a light-emitting element of the print head, which can easily adapt to increase of image forming ability (higher resolution) and reduce cost of the apparatus can be realized.

In other words, in the image forming apparatus 100, after the memory controller 722 controls the read line in the burst access unit by the coarse adjustment processing, the fine adjustment processing section 725 controls the read line in the pixel unit by the fine adjustment processing and therefore, there is no need to have a line buffer with the total maximum correction amount throughout the main scanning direction. Consequently, the amount of RAM of the line buffer can be reduced and thus the cost of the apparatus can be reduced.

In the above-described example, correction of misalignment (skew) which occurs in image forming due to mounting status of the LPH is described, however, misalignment (bow) which occurs in image forming due to an alignment status of a light-emitting element of the LPH can also be corrected.

In bow correction, writing unit setting information 941 is stored for each LED array chip mounted in the LPH and coarse adjustment correction and fine adjustment correction are performed per pixel corresponding to the LED array chip. Also, skew correction and bow correction can be performed simultaneously.

According to an aspect of the preferred embodiments of the present invention, there is provided an image forming apparatus, comprising:

an image memory to store image data to form an image composed of a plurality of pixels aligned in a main scanning direction and a sub-scanning direction;

a print head to form an image on a sheet based on the image data; and

a correction section to perform correction processing on the image data read from the image memory to correct misalignment which occurs when an image is formed due to mounting status of the print head or alignment status of a light-emitting element of the print head, wherein

the correction section includes:

a memory which can perform burst transfer, to store image data per pixel read from the image memory with the main scanning direction of the image corresponding to a column address and the sub-scanning direction of the image corresponding to a row address;

a first control section to perform address control when data is transferred in the memory;

a plurality of stages of line buffers to store image data throughout the main scanning direction transferred in burst access unit from the memory; and

a second control section to select image data to output per main scanning coordinate among a plurality of lines of image data stored in the plurality of stages of line buffers, wherein

the first control section successively writes the image data per pixel in the burst access unit in the memory and reads the image data per pixel in the burst access unit while controlling the address of the memory according to a first control signal generated based on previously set information concerning correction to transfer the image data to the line buffer; and

the second control section selects image data to output per main scanning coordinate among the plurality of lines of image data stored in the plurality of stages of line buffers according to a second control signal generated based on the information concerning correction.

Preferably, in the image forming apparatus,

the first control section performs address control when data is transferred in the memory with a predetermined number of lines of image data as the burst access unit;

each of the plurality of stages of line buffers can store the predetermined number of lines of image data; and

the second control section selects the predetermined number of lines of image data per main scanning coordinate.

Preferably, in the image forming apparatus,

the image forming apparatus is a tandem-type image forming apparatus which includes a series of photoreceptor drums of a plurality of colors and forms a color image on a sheet by successively transferring each color in one process; and

the first control section adjusts timing of forming an image of each color by using the memory.

According to the preferred embodiment, an image forming apparatus which can correct misalignment (skew/bow) in image forming due to mounting status of a print head or an alignment status of a light-emitting element of the print head, which can easily adapt to increase of image forming ability (higher resolution) and reduce cost of the apparatus can be realized.

In other words, in the image forming apparatus, after the first control section controls the read line or the write line in the burst access unit by the coarse adjustment processing, the second control section controls the read line in the pixel unit by the fine adjustment processing and therefore, there is no need to have a line buffer with the total maximum correction amount throughout the main scanning direction. Consequently, the amount of RAM of the line buffer can be reduced and thus the cost of the apparatus can be reduced.

According to another aspect of the preferred embodiments of the present invention, there is provided an image forming apparatus comprising:

an image memory to store image data to form an image composed of a plurality of pixels aligned in a main scanning direction and a sub-scanning direction;

and

a correction section to perform correction processing on the image data read from the image memory to correct misalignment which occurs when an image is formed due to mounting status of a print head or alignment status of a light-emitting element of the print head, wherein

the correction section includes:

a memory which can perform burst transfer, to store image data per pixel read from the image memory with the main scanning direction of the image corresponding to a column address and the sub-scanning direction of the image corresponding to a row address;

a first control section to perform address control when data is transferred in the memory;

a plurality of stages of line buffers to store image data throughout the main scanning direction transferred in burst access unit from the memory; and

a second control section to select image data to output per main scanning coordinate among a plurality of lines of image data stored in the plurality of stages of line buffers, wherein

the first control section writes the image data per pixel in the burst access unit while controlling the address of the memory according to a first control signal generated based on previously set information concerning correction and successively reads in the burst access unit the written image data to transfer to the line buffer; and

the second control section selects image data to output per main scanning coordinate among the plurality of lines of image data stored in the plurality of stages of line buffers according to a second control signal generated based on the information concerning correction.

Preferably, in the image forming apparatus,

the first control section performs address control when data is transferred in the memory with a predetermined number of lines of image data as the burst access unit;

each of the plurality of stages of line buffers can store the predetermined number of lines of image data; and

the second control section selects the predetermined number of lines of image data per main scanning coordinate.

Preferably, in the image forming apparatus,

the image forming apparatus is a tandem-type image forming apparatus which includes a series of photoreceptor drums of a plurality of colors and forms a color image on a sheet by successively transferring each color in one process; and

the first control section adjusts timing of forming an image of each color by using the memory.

According to the preferred embodiment, an image forming apparatus which can correct misalignment (skew/bow) in image forming due to mounting status of a print head or an alignment status of a light-emitting element of the print head, which can easily adapt to increase of image forming ability (higher resolution) and reduce cost of the apparatus can be realized.

In other words, in the image forming apparatus, after the first control section controls the read line or the write line in the burst access unit by the coarse adjustment processing, the second control section controls the read line in the pixel unit by the fine adjustment processing and therefore, there is no need to have a line buffer with the total maximum correction amount throughout the main scanning direction. Consequently, the amount of RAM of the line buffer can be reduced and thus the cost of the apparatus can be reduced.

Although various exemplary embodiments have been shown and described, the invention is not limited to the embodiments shown. Therefore, the scope of the invention is intended to be limited solely by the scope of the claims that follow and not by the above explanation, and it is intended that the present invention covers modifications and variations that come within the scope of the appended claims and their equivalents.

The present U.S. Patent Application claims priority under the Paris Convention of Japanese Patent Application No. 2008-015092 filed on Jan. 25, 2008 to the Japanese Patent Office, which shall be a basis for correcting mistranslations.

What is claimed is:

1. An image forming apparatus, comprising:
an image memory to store image data to form an image composed of a plurality of pixels aligned in a main scanning direction and a sub-scanning direction;
a print head to form an image on a sheet based on the image data; and
a correction section to perform correction processing on the image data read from the image memory to correct misalignment which occurs when an image is formed due to mounting status of the print head or alignment status of a light-emitting element of the print head, wherein
the correction section includes:
a memory which can perform burst transfer, to store image data per pixel read from the image memory with the main scanning direction of the image corresponding to a column address and the sub-scanning direction of the image corresponding to a row address;
a first control section to perform address control when data is transferred in the memory;
a plurality of stages of line buffers to store image data throughout the main scanning direction transferred in burst access unit from the memory; and
a second control section to select image data to output per main scanning coordinate among a plurality of lines of image data stored in the plurality of stages of line buffers, wherein
the first control section successively writes the image data per pixel in the burst access unit in the memory and reads the image data per pixel in the burst access unit while controlling the address of the memory according to a first control signal generated based on previously set information concerning correction to transfer the image data to the line buffer; and
the second control section selects image data to output per main scanning coordinate among the plurality of lines of image data stored in the plurality of stages of line buffers according to a second control signal generated based on the information concerning correction.

2. The image forming apparatus of claim 1, wherein
the first control section performs address control when data is transferred in the memory with a predetermined number of lines of image data as the burst access unit;
each of the plurality of stages of line buffers can store the predetermined number of lines of image data; and
the second control section selects the predetermined number of lines of image data per main scanning coordinate.

3. The image forming apparatus of claim 1, wherein
the image forming apparatus is a tandem-type image forming apparatus which includes a series of photoreceptor drums of a plurality of colors and forms a color image on a sheet by successively transferring each color in one process; and
the first control section adjusts timing of forming an image of each color by using the memory.

4. An image forming apparatus, comprising:
an image memory to store image data to form an image composed of a plurality of pixels aligned in a main scanning direction and a sub-scanning direction; and
a correction section to perform correction processing on the image data read from the image memory to correct misalignment which occurs when an image is formed due to mounting status of a print head or alignment status of a light-emitting element of the print head, wherein
the correction section includes:
a memory which can perform burst transfer, to store image data per pixel read from the image memory with the main scanning direction of the image corresponding to a column address and the sub-scanning direction of the image corresponding to a row address;
a first control section to perform address control when data is transferred in the memory;
a plurality of stages of line buffers to store image data throughout the main scanning direction transferred in burst access unit from the memory; and
a second control section to select image data to output per main scanning coordinate among a plurality of lines of image data stored in the plurality of stages of line buffers, wherein
the first control section writes the image data per pixel in the burst access unit while controlling the address of the memory according to a first control signal generated based on previously set information concerning correction and successively reads in the burst access unit the written image data to transfer to the line buffer; and
the second control section selects image data to output per main scanning coordinate among the plurality of lines of image data stored in the plurality of stages of line buffers according to a second control signal generated based on the information concerning correction.

5. The image forming apparatus of claim 4, wherein
the first control section performs address control when data is transferred in the memory with a predetermined number of lines of image data as the burst access unit;
each of the plurality of stages of line buffers can store the predetermined number of lines of image data; and
the second control section selects the predetermined number of lines of image data per main scanning coordinate.

6. The image forming apparatus of claim 4, wherein
the image forming apparatus is a tandem-type image forming apparatus which includes a series of photoreceptor drums of a plurality of colors and forms a color image on a sheet by successively transferring each color in one process; and
the first control section adjusts timing of forming an image of each color by using the memory.
